(19) United States
(12) Patent Application Publication
(10) Pub. No.: US 2010/0079702 A1
(43) Pub. Date: Apr. 1, 2010

(54) SURFACE LIGHT SOURCE DEVICE AND LCD UNIT

(76) Inventors: Takahiro Ito, Tokyo (JP); Naoya Sone, Tokyo (JP)

Correspondence Address: CERMAK KENEALY VAIDYA & NAKAJIMA LLP, 515 EAST BRADDOCK RD SUITE B, Alexandria, VA, 22314, US

(21) Appl. No.: 12/569,234

(22) Filed: Sep. 29, 2009

(30) Foreign Application Priority Data
Sep. 29, 2008 (JP) 2008-251300

(51) Int. Cl. G02F 1/1335; F21V 7/04

(52) U.S. Cl. 349/64; 362/606; 362/607; 349/67

(57) ABSTRACT

The disclosed subject matter includes providing a surface light source device using a plurality of different color light-emitting chips that can emit light with uniform color and a LCD unit having the same qualities. The surface light source device can include a light guide having a light incoming surface and a light-emitting surface, and light sources including the light-emitting chips located adjacent the light incoming surfaces. The light-emitting surface can include a light-mixing area that is spaced a distance L away from the light incoming surface, and the widest interval between the adjacent light-emitting chips is configured to be L/27 or less. Light emitted from the light sources can generate a mixture light with very little color variability in the light-mixing area, and the light can be emitted from the light-emitting surface other than the light-mixing area. Therefore, the LCD unit that includes a LCD located toward the light guide can illuminate the display with uniform color light.

This application claims the priority benefit under 35 U.S.C. §119 of Japanese Patent Application No. 2008-251300 filed on Sep. 29, 2008, which is hereby incorporated in its entirety by reference.

### BACKGROUND

1. Field

The presently disclosed subject matter relates to a surface light source device and a LCD unit including the same, and more particularly to a surface light source device which can be configured to emit uniform color light with a plurality of different color LEDs. Thus, the surface light source device can be employed as a light source for a back light unit located adjacent a liquid crystal display (LCD) of a personal computer and the like, in which the surface light source device can also illuminate the display with a uniform white light.

2. Description of the Related Art

Conventional optical transmission displays such as LCDs and the like are typically illuminated from a rear portion thereof by a surface light source device in order to light their displays. The surface light source device for a back light unit that illuminates from the back of the display unit can be frequently used as a surface light source device of an edge light type because the thickness of the device can be minimized.

The surface light source device of the edge light type includes a light guide that can emit a planar light from one surface by receiving light with an light incoming surface thereof and a light source that is located adjacent the incoming surface. The one light-emitting surface is typically located perpendicular to the light incoming surface, and light emitted from the light source can enter into the light guide via the light incoming surface. The light can be emitted from the one light-emitting surface of the light guide while diffusing the light in the light guide.

In the surface light source device of the edge light type, a plurality of point light sources, such as LEDs and the like, are used as the light source from which light enters into the light guide via the light incoming surface. For example, a surface light source device using a plurality of different color LEDs is disclosed in Patent Document No. 1 (Japanese Patent Application Laid Open H10-247411). FIG. 19 is a cross-section view depicting a basic structure for a conventional surface light source using three different color LEDs that is disclosed in Patent Document No. 1.

The conventional light source 56 includes a red LED 58R, a green LED 58G and a blue LED 58B that are mounted on a board 55 so as to approximate with respect to each other, and a transparent encapsulating resin 59 for encapsulating the LEDs 58R, 58G and 58B therewith. The conventional surface light source includes a light guide 52 that includes a concave portion 57 formed as a light incoming surface, and the light source 56 that faces the concave surface 57. Therefore, each of lights emitted from the LEDs 58R, 58G and 58 B of the light source 56 may enter into the light guide 52 via the concave surface 57 on which light from each of the LEDs 58R, 58G, and 58B is dispersed.

The above-referenced Patent Document is listed below and is hereby incorporated with its English abstract in its entirety.

1. Patent Document No. 1: Japanese Patent Application Laid Open H10-247411

According to the conventional surface light source device that is disclosed in Patent Document No. 1, the light source 56 forces the three colors of light emitted from the LEDs 58R, 58G and 58B to mix together thoroughly in the transparent encapsulating resin 59 before entering into the light guide 52 by approximating the LEDs 58R, 58G and 58B with respect to each other. Therefore, the light that enters into the light guide 52 from the light source 56 can become white light, and color variability on an area that is close to the light incoming surface of the light guide 52 can be prevented.

However, even if distances between the LEDs 58R, 58G and 58B are approximated as close as possible, each of these distances may be limited and cannot become zero. To that end, a thickness of the transparent encapsulating resin 59 might need to be relatively increased in order to sufficiently mix the light emitted from the LEDs 58R, 58G and 58B. Therefore, because energy losses of the light emitted from the LEDs 58R, 58G and 58B increase in the transparent encapsulating resin 59, the conventional surface light source can be subject to a problem such that a light flux emitted from the light guide 52 might be decreased.

Moreover, in the surface light source device that is disclosed in Patent document No. 1, the light that enters into the light guide 52 from the light source 56 is dispersed on the concave surface 57 that is formed on the light incoming surface of the light guide 52. Therefore, a portion of the light emitted by the surface light source device can be emitted from a surface of the light guide 52 other than the light-emitting surface (e.g. a side surface of the light emitting guide 52). Thus, the conventional light source device also can be subject to a problem such that the light use efficiency of the light emitted from the light source 56 may decrease.

The disclosed subject matter has been devised to consider the above and other problems and characteristics. Thus, embodiments of the disclosed subject matter can include a surface light source device using a plurality of LEDs that can respectively emit different single color light, which can efficiently emit light with very little color variability and high brightness. In addition, the surface light source device can maintain a simple structure. This simple structure can obviate the use of a concave surface. The disclosed subject matter can also include a LCD unit using the surface light source device as described above. The LCD unit can be configured to decrease the color variability of the display.

### SUMMARY

The presently disclosed subject matter has been devised in view of the above and other problems and characteristics in the conventional art, and to make certain changes to the existing structures of conventional surface light sources in accordance with various evaluation tests. An aspect of the disclosed subject matter includes providing a surface light source device that can emit lights with high brightness and uniform color brightness from an operative light-emitting area of a light guide. Furthermore, the surface light source device can maintain a simple structure even when improving the color variability and the brightness thereof. Thus, the surface light source device of the disclosed subject matter can be employed as a light source for a back light unit located at the rear of a LCD panel of a personal computer, computer monitor, and the like.

Another aspect of the disclosed subject matter includes providing a LCD unit using the above-described surface light source device that can exhibit the display with high color uniformity and high brightness. In addition, because the LCD unit can be formed with a substantially thin profile, it can be employed as a display unit for a personal computer, etc.

According to an aspect of the disclosed subject matter, a surface light source device can include: a light guide made from a transparent resin and having a first surface, a second surface, and a light incoming surface, the light incoming surface thereof being substantially perpendicular to the first surface, and the light guide including a light-mixing area extends from the light incoming surface to a virtual surface that can be substantially parallel with the light incoming surface and that can be a distance L away from the light incoming surface; and a reflecting sheet having a first surface and a second surface, and the first surface thereof can be located adjacent the second surface of the light guide. The surface light source device can also include a plurality of light sources located adjacent the light incoming surface of the light guide so as to align along the light incoming surface, each of the light sources can include a plurality of light-emitting chips that emits a different color light having a light-emitting angle with respect to each other, each of the light-emitting chips can be located at an interval in the light source so as to face the light incoming surface of the light guide substantially in parallel with the light incoming surface and the virtual extending surface of the first surface of the light guide, and wherein the widest interval between the adjacent light-emitting chips located in each of the light sources can be substantially equal to or less than L/27.

According to another aspect of the presently disclosed subject matter, different colors of light emitted from the light sources can enter into the light guide via the light incoming surface of the light guide, and the resulting mixture of the colored light can be emitted from the first surface of the light guide other than the light-mixing area after mixing the different color lights in the light-mixing area. The color variability indexes of the so-mixed light can become smaller than 0.006, and therefore the surface light source device can emit light with very little color variability.

In another aspect according the presently disclosed subject matter, the surface light source device can further include a casing that can be located adjacent the light sources so as to cover as least the light-mixing area of the light guide, and a diffusing sheet having a first surface and a second surface can be located adjacent the first surface of the light guide. In addition, a uniform light-emitting treatment can be formed on the second surface of the light guide. Therefore, the surface light source device can emit light with uniform color and uniform brightness from the first surface of the light guide other than the light-mixing area while preventing the energy loss of the light caused in the light guide, a part other than the light guide and so on.

In another aspect of the presently disclosed subject matter, the plurality of light-emitting chips can include two green LEDs, a red LED, and a blue LED, and the light-emitting chips can be located so as to adjacently align the red LED and the blue LED between the two green LEDs. Each of the light-emitting angles of the light-emitting chips can be configured to become substantially zero degree with respect to the light incoming surface of the light guide, and each of the light distribution patterns of the light-emitting chips can be configured to form a lambertian radiation pattern substantially in parallel with the first surface of the light guide.

According to another aspect of the presently disclosed subject matter, the surface light source device can emit a favorable white light with uniform color and high brightness using the above-described light-emitting chips, because the light use efficiency can improve even when the light incoming surface of the light guide is formed a flat surface.

In another aspect of the disclosed subject matter, a liquid crystal display unit can include the above-described surface light source device, and can include: at least one prism sheet having a first surface and a second surface, the second surface thereof located adjacent the first surface of the diffusing sheet; and a liquid crystal display located on the first surface of the at least one optical sheet.

According to this aspect of the disclosed subject matter, the above-described surface light source device can illuminate the LCD with uniform color brightness and a simple structure. Thus, the disclosed subject matter can provide a surface light source device with uniform color brightness and a LCD unit having the same qualities.

### BRIEF DESCRIPTION OF THE DRAWINGS

These and other characteristics and features of the disclosed subject matter will become clear from the following description with reference to the accompanying drawings, wherein:

FIG. 1 is an exploded perspective view showing a principal structural part in an exemplary embodiment of a surface light source device made in accordance with principles of the disclosed subject matter;

FIG. 2 is a top view showing a light guide and a plurality of light sources in the surface light source device shown in FIG. 1;

FIG. 3 is a cross-section top view showing one exemplary light source of the light sources shown in FIG. 2 that is located on a light incoming surface of a light guide;

FIG. 4 is a diagram showing a light distribution pattern of the light source shown in FIG. 3;

FIG. 5 is a diagram showing an exemplary value of chromaticity measured in evaluation tests of testing samples made in accordance with the disclosed subject matter;

FIGS. 6a and 6b are respectively graphs showing relations between color variability indexes ΔCx and ΔCy and an LED mounting pitch P in evaluation test 1;

FIGS. 7a and 7b are respectively graphs showing relations between color variability indexes ΔCx and ΔCy and an LED mounting pitch P in evaluation test 2;

FIGS. 8a and 8b are respectively graphs showing relations between color variability indexes ΔCx and ΔCy and an LED mounting pitch P in evaluation test 3;

FIGS. 9a and 9b are respectively graphs showing relations between color variability indexes ΔCx and ΔCy and an LED mounting pitch P in evaluation test 4;

FIGS. 10a and 10b are respectively graphs showing relations between color variability indexes ΔCx and ΔCy and an LED mounting pitch P in evaluation test 5;

FIGS. 11a and 11b are respectively graphs showing relations between color variability indexes ΔCx and ΔCy and an LED mounting pitch P in evaluation test 6;

FIGS. 12a and 12b are respectively graphs showing relations between color variability indexes ΔCx and ΔCy and an LED mounting pitch P in evaluation test 7;

FIGS. 13a and 13b are respectively graphs showing relations between color variability indexes ΔCx and ΔCy and an LED mounting pitch P in evaluation test 8;

FIGS. 14a and 14b are respectively graphs showing relations between color variability indexes ΔCx and ΔCy and an LED mounting pitch P in evaluation test 9;

FIGS. 15a and 15b are respectively graphs showing relations between color variability indexes ΔCx and ΔCy and an LED mounting pitch P in evaluation test 10;

FIG. 16 is a table showing testing factors and testing results for permissible upper limits of the LED mounting pitches P in the evaluation tests 1 to 10;

FIG. 17 is a graph showing relations between light-mixing distances L and intervals W for location of light sources and the permissible upper limits of the LED mounting pitches P in the evaluation tests 1, 9 and 10;

FIG. 18 is a partial enlarged cross-section view depicting a LCD unit using the surface light source device made in accordance with principles of the disclosed subject matter; and

FIG. 19 is a cross-section view depicting a basic structure for a conventional surface light source using three different color LEDs.

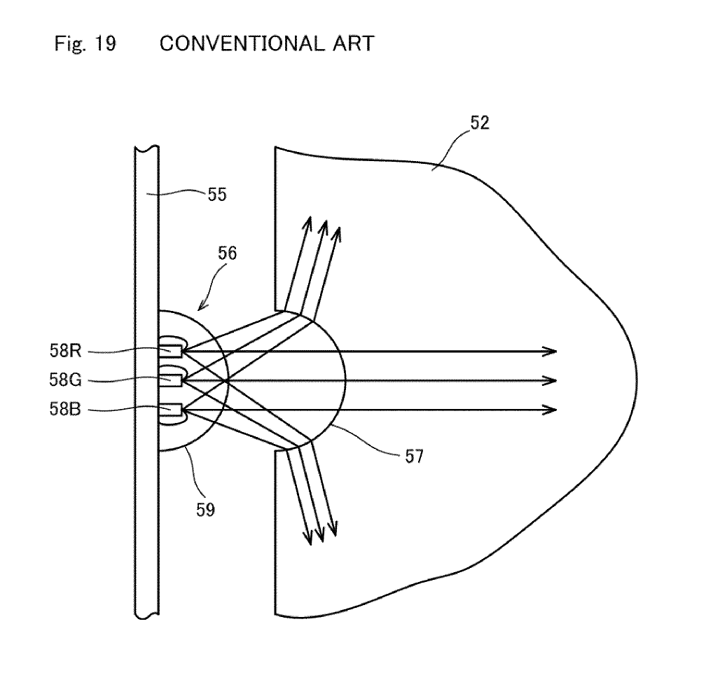

### DETAILED DESCRIPTION OF EXEMPLARY EMBODIMENTS

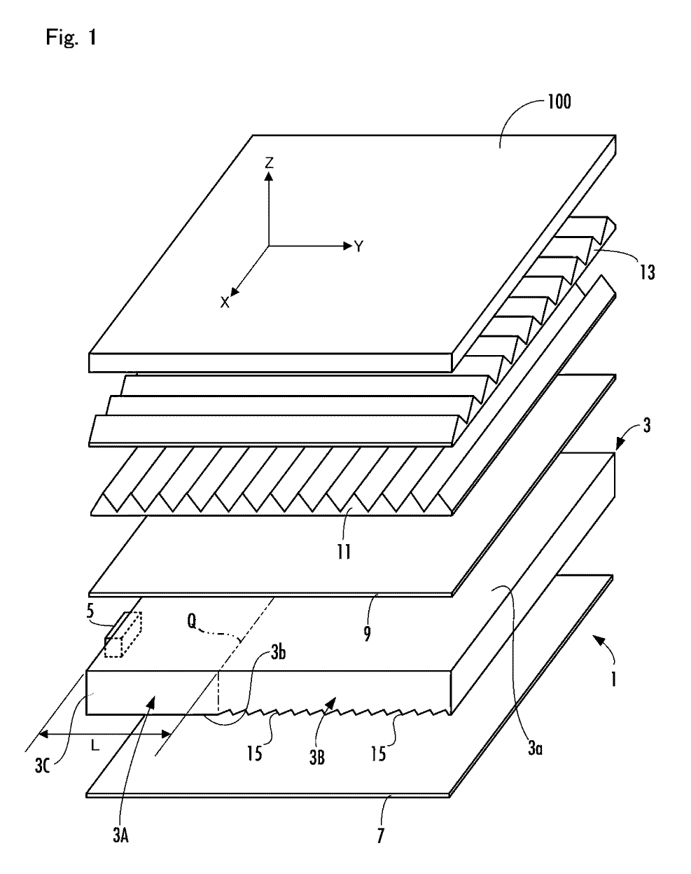

A basic structure in an exemplary embodiment of a surface light source device of the disclosed subject matter will now be described in detail with reference to FIG. 1 to FIG. 4. FIG. 1 is an exploded perspective view showing a structural part of an exemplary embodiment of a surface light source device made in accordance with principles of the disclosed subject matter.

The surface light source device 1 can be used as a back light unit for a LCD panel 100. The surface light source device 1 can include: a light guide 3 having a first surface 3a and a second surface 3b and a light incoming surface 3C; a light source unit that can include a plurality of light sources 5 located adjacent the light incoming surface of the light guide 3; a reflecting sheet 7 having a second surface and a first surface that is located adjacent the second surface 3b of the light guide 3; a diffusing sheet 9 having a first surface and a second surface that is located adjacent the first surface 3a of the light guide 3; a first prism sheet 11 having a first surface and a second surface that is located adjacent the first surface of the diffusing sheet 9; a second prism sheet 13 having a first surface and a second surface that is located adjacent the first surface of the first prism sheet 11. One of the plurality of light sources 5 is shown in FIG. 1.

The light guide 3 can be made from a transparent material and can be formed in a rectangular shape. A refractive index of the light guide 3 can be within a range of approximately 1.49 to 1.58, and therefore the transparent resin such as an acrylic resin, a polycarbonate resin and the like can be used to form the light guide 3. The first surface 3a of the light guide 3 can operate as a light-emitting surface for the surface light source device 1.

The light incoming surface 3C of the light guide 3 can operate as an incoming surface for light entering into the light guide 3. The light entering through the light incoming surface 3C can be emitted from the light guide 3 through the first surface 3a of the light guide 3. The light incoming surface 3C can be substantially perpendicular to the first surface 3a and can be formed in a flat shape. For convenience in the following descriptions, a direction that is perpendicular to the first surface 3a of the light guide 3 is defined as Z axial direction, a direction that is parallel with the light incoming surface 3C of the light guide 3 is defined as X axial direction, and a direction that is perpendicular to the light incoming surface 3C is defined as Y axial direction, where the X, Y and Z directions are orthogonal to each other.

In the surface light source device 1 of the disclosed subject matter, the diffusing sheet 9 can overlie the first surface 3a of the light guide 3, and the first prism sheet 11 and the second prism sheet 13 can overlie the diffusing sheet 9. The LCD panel 100 can overlie a first surface of the second prism sheet 13. Therefore, the panel 100 can be provided with the light emitted from the first surface 3a of the light guide 3 through the diffusing sheet 9, the first prism sheet 11 and second prism sheet 13, in turn.

In this case, the diffusing sheet 9 can be configured as an optical resin film and can also be configured to diffuse the incoming light emitted from the first surface 3a of the light guide 3 and transmit the diffused light. The prism sheets 11 and 13 can be configured with or made from a transparent material and can be configured to orient the diffused light transmitted from the diffusing sheet 9 in a predetermined direction.

The prism sheet 11 can include a plurality of triangular prisms such that each triangular prism is located at a regular interval in the Y axial direction and extends in the X axial direction on the first surface thereof, and can be configured to orient the light distribution relative to the X axial direction. The prism sheet 13 can include a plurality of triangular prisms such that each triangular prism is located at a regular interval in the X axial direction and is extends in the Y axial direction on the first surface thereof, and can be configured to orient the light distribution relative to the Y axial direction.

The second surface 3b of the light guide 3 can be configured to diffuse incoming light that enters into the light guide 3 from the incoming surface 3C and to cause the diffused light to be emitted from the first surface 3a. The second surface 3b can be located adjacent the first surface of the reflecting sheet 7. The first surface of the reflecting sheet 7 can reflect an incoming light transmitted from the second surface 3b thereon, and the reflective light can enter into the light guide 3 via the second surface 3b of the light guide 3 with the reflecting sheet 7.

The second surface 3b of the light guide 3 can include a plurality of knurls 15 located in the Y axial direction so as to extend in the X axial direction as a uniform light-emitting treatment. The exemplary embodiment of the disclosed subject matter can emit light from the first surface 3a of the light guide 3 after diffusing the light that reaches the second surface 3b in the light guide 3 and the light that enters into the light guide 3 by reflecting on the first surface of the reflecting sheet 7 with the plurality of knurls 15. The knurls 15 can be formed within a range of an operative light-emitting area 3B described in detail later.

The reflecting sheet 7 can be made from multiple layers by forming a metallic layer having high reflectivity such as a silver, an aluminum and the like on a polyester film using an evaporation method, an sputtering method, etc. A thin resin (e.g. ESR made by 3M Limited) can also be formed on the polyester film.

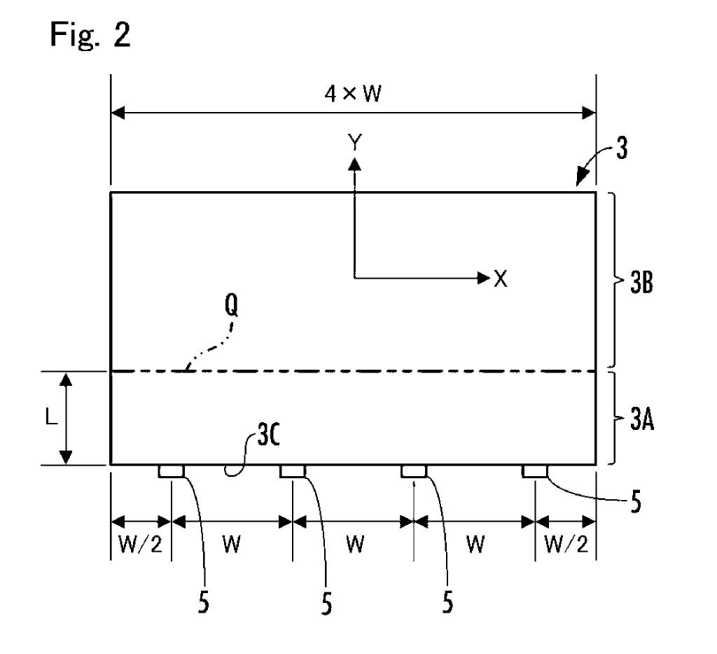

FIG. 2 is a top view showing the light guide 3 and the plurality of light sources 5 in the surface light source device shown in FIG. 1. The light sources 5 (the light source unit) can be located adjacent the light incoming surface 3C of the light guide 3 so that a light-emitting surface of the light sources 5 can face the light incoming surface 3C. The light sources 5 can be aligned in the X axial direction of the light incoming surface 3C at a regular interval W. In FIG. 2, the interval W can be used to determine the division of a length of the light guide 3 in the X axial direction based on the number of the light sources 5 (for example, 4×W when four light sources 5 are used). The interval W is hereinafter referred to as a light source mounting interval W.

The respective intervals between each of both ends of the incoming surface 3C in the X axial direction and each of two outer light sources that are located close to each of the both ends can become the same interval W/2. In other words, the four light sources 5 (collectively referred to as the light source unit) can be located at the light source mounting interval W in the X axial direction so that a center of the four light sources 5 can correspond to a center of the incoming surface 3C in the X axial direction.

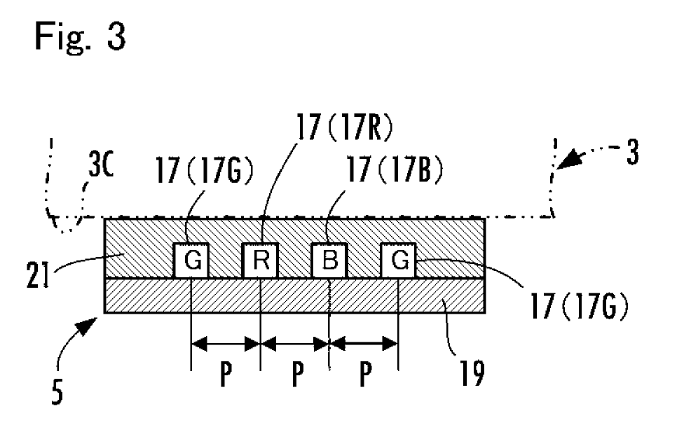

FIG. 3 is a cross-section top view showing one exemplary light source of the light source devices shown in FIG. 2 that is located on the light incoming surface 3C of the light guide 3. The one of the light sources 5 can include a plurality of LEDs 17 that emits a different single color light, respectively. More specifically, the one of the light sources 5 can include the LEDs 17 that are mounted on a base board 19 so as to align at a regular interval P and a transparent encapsulating resin 21 that encapsulates the LEDs 17 therewith so as to form in a three-dimensional shape. The interval P is hereinafter referred to as an LED mounting pitch P.

In the exemplary embodiment of the disclosed subject matter, the LED mounting pitch P can be the widest interval when the LED mounting pitch P can become substantially constant between the adjacent LEDs with respect to each other so as not to overlap. At least one of the light sources 5 can include two green LEDs 17G that emit a green single color light, a red LED 17R that emits a red single color light and a blue LED 17B that emits a blue single color light. Therefore, the one of the light sources 5 can emit light that is composed of three individual colors of green, red and blue.

The four LEDs can be configured to align the green LED 17G, the red LED 17R, the blue LED 17B and the green LED 17G in turn. That is to say, the green LEDs 17G can be located adjacent both sides of the four LEDs. In this case, the mixture light of the three single color lights of green, red and blue can become white light. When a favorable white light as a back light unit for a LCD panel is generally composed of these three single color lights, an amount of green light should increase in order to emit a white light having a favorable brightness as the back light unit because the white light includes a large amount of green light.

Therefore, an exemplary number ratio among the green LED, the red LED and the blue LED can be 2:1:1, respectively, and the light source(s) 5 of the exemplary embodiment can include the two green LEDs 17G, the red LED 17R and the blue LED 17B. A description of the advantage(s) of positioning the green LED 17G, the red LED 17R, the blue LED 17B and the green LED 17G in the four LEDs 17 follow.

Lighting colors emitted from both edges of the first surface 3a of the light guide 3 in the X axial direction may be subject to those of the both LEDs that are located close to the both edges. Therefore, when the light-emitting colors emitted from the both edges of the first surface 3a in the X axial direction are the same color, it may be advantageous for the light sources 5 to conform to those of the both LEDs that are located close to the both edges.

To that end, in the light source(s) 5 that includes the four LEDs 17 in this exemplary embodiment, the LEDs 17 can be configured to align the green LED 17G, the red LED 17R, the blue LED 17B and the green LED 17G in turn. Therefore, the green LEDs 17G can be located adjacent both edges of the LEDs 17 in the X axial direction.

When the three color lights of red, green and blue are used as a light source in a surface light source device in accordance with the disclosed subject matter and when a color reproducibility thereof that is equal to or greater than the value of a standard in the NTSC system on the chromaticity coordinate in accordance with CIE 1931 standard is accomplished by the light source 5, advantageous peak wavelengths of a red emission spectrum, a green emission spectrum and a blue emission spectrum can lie within the exemplary ranges from 630 to 650 nanometers, from 520 to 550 nanometers, and from 440 to 460 nanometers, respectively.

Thus, the respective peak wavelengths of emission spectrums of the red LED 17R, the green LED 17G and the blue LED 17B can be within the above-described advantageous ranges, respectively. Further, it can be advantageous to position the color temperature of white light for a back light unit of an LCD panel to be within a range of 5,000 K to 30,000 K on the blackbody in the chromaticity coordinate in accordance with the CIE 1931 standard, and to position a deviation value Δuv of the color temperature to be within a range of −0.02 to +0.02 from the blackbody.

Thus, the ratio of the three light fluxes emitted from the light source(s) 5 can be configured to emit the mixture light that is composed of the three color lights in which the respective peak wavelengths are within the respective advantageous ranges. The above-described light sources 5 (collectively referred to as the light source unit) can be located adjacent the light incoming surface 3C of the light guide 3 so that the respective LEDs 17 of the light sources 5 can be aligned along the light incoming surface 3C in the X axial direction. Each of the LEDs 17 can be a cube 300 micro meters on a side, and a distance between a light-emitting surface of the LEDs 17 and the light incoming surface 3C can be approximately 0.3 to 0.5 millimeters.

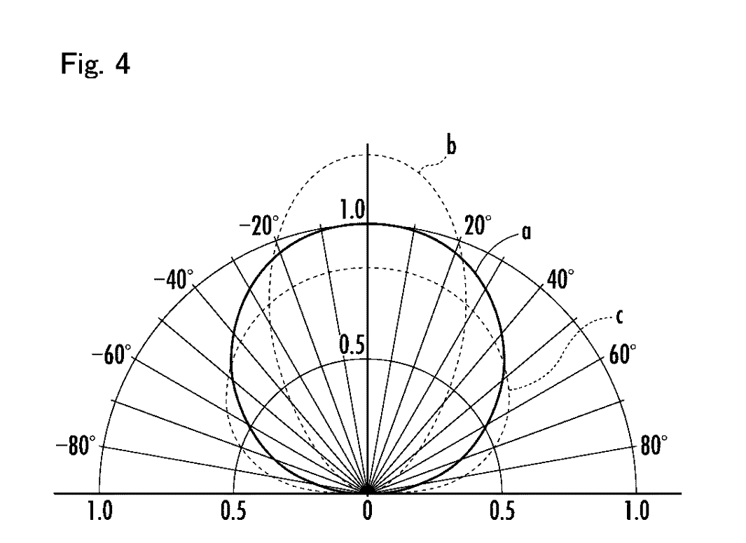

FIG. 4 is a diagram showing a light distribution pattern of the light source shown in FIG. 3. The light distribution pattern on the surface of the X and the Y axial direction can be shown by a solid line a in FIG. 4. Values with respect to X axis and Y axis are shown as relative values of the light intensity emitted from the light source in the respective directions. The light distribution pattern shown by the solid line a is known as a lambertian radiation pattern.

The lambertian radiation pattern is a variable light distribution pattern (and will be described later) with respect to a light-emitting angle θ in the Y axial direction in the light intensity distribution emitted from the LEDs 17 (of at least one of the light sources 5). That is, the light distribution pattern can include a peak value of the light intensity within the range of −5 degrees to +5 degrees, and the light intensity can gradually decrease as the light-emitting angle θ becomes larger than the range of −5 degrees to +5 degrees. The light intensity can become half of the peak value within the range of −65 degrees to −55 degrees and within the range of +55 degrees to +65 degrees. When the light-emitting angle θ is larger than +65 degrees or smaller than −65 degrees, the light intensity can become smaller than half of the peak value.

In order to realize the lambertian radiation pattern in each of the light sources 5, the LEDs 17 can be provided with a reflector, and/or the transparent encapsulating resin 21 can be provided with a diffusing material, a lens, etc. The above-described light distribution pattern can be a light distribution pattern on the surface of the X and the Y axial direction. However, the light distribution pattern on a surface of the Y and the Z axial direction is not limited to a lambertian radiation pattern. Each of the light sources 5 can include a light distribution pattern such as shown by dotted lines b or c shown in FIG. 4 on the surface of the Y and the Z axial direction.

The basic structure of the surface light source device 1 in the exemplary embodiment is described above. The three different colors of light emitted from the light sources 5 can enter into the light guide 3 via the light incoming surface 3C in the surface light source device 1. The three different colors of light can be mixed in the light guide 3 via the second surface 3b having the uniform light-emitting treatment and the reflecting sheet 7, and the resulting mixed light (i.e., white light) can be emitted from the first surface 3a of the light guide 3.

An light-mixing area 3A can extend from the light incoming surface 3C to a double-dashed line Q (designating the location of a virtual surface that is substantially parallel with the incoming surface 3C) that is a distance L away in the Y axial direction from the light incoming surface 3C, as shown in FIGS. 1 and 2. This light mixing area 3A can operate as a function area for mixing the three different colors of light that enter into the light guide 3 from all of the light sources 5 (i.e., the light source unit). The distance L is hereinafter referred to as a light-mixing distance L.

The light-mixing area 3A on the first surface 3a of the light guide 3 may not emit a favorable white light as a surface light source device for the LCD panel 100 because the three different colors of light may not be sufficiently mixed for emitting an advantageous white light in the light-mixing area 3A. In other words, the light-mixing area 3A may not be effectively used as a surface light source for the LCD panel 100 on the first surface 3a of the light guide 3.

A light-emitting area 3B on the first surface 3a that starts at the distance L in the Y axial direction away from the light incoming surface 3C and extends from the double-dashed line Q shown in FIG. 1 toward a surface opposite the light incoming surface 3C can operate as a functional area for the LCD panel 100 because the three different color lights can be mixed sufficiently for emitting an advantageous white light.

In the surface light source device 1 of the exemplary embodiment, the operative light-emitting area 3B on the first surface 3a can be effectively used as a surface light source for the LCD panel 100. Therefore, because the light-mixing area 3A on the first surface 3a may not be advantageously used as the surface light source for the LCD panel 100, the light-mixing area 3A can be covered with a casing for attaching these optical components, as will be described later. That is to say, the light-mixing area 3A on the first surface 3a may be covered with the casing relative to the Z axial direction, and light emitted from the light-mixing area 3A toward the LCD panel 100 can be blocked.

In this case, the light-mixing area 3A on the first surface 3a also can be covered with a sheet through which light cannot be transmitted, and also a part of the first surface of the diffusing sheet 9 that faces the light-mixing area 3A can be covered so as not to transmit the light emitted from the light-mixing area 3A.

In the exemplary embodiment of the disclosed subject matter, a relation between the light-mixing distance L and the LED mounting pitch P can be configured to conform to the following formula:

L/P≧27 (formula 1).

In this case, the light-mixing area 3A can be covered with the casing, and the light-mixing distance L can become a minimum width from the light incoming surface 3C that is covered by the casing. When the LCD panel 100 is a display for a LCD television, the light-mixing distance L can be within the range of 10 to 100 millimeters.

The LED mounting pitch P can be configured to conform to the formula 1. When the mounting pitch P is less than or equal to L/27, the light-mixing distance L and the LED mounting pitch P may be satisfied under the formula 1. However, each of the light sources 5 can be limited to a respective size of each of the LEDs 17, a manufacturing method for the LEDs 17, etc. Therefore, the LED mounting pitch P can be determined so as to become approximately L/30 while satisfying the formula 1.

In an exemplary embodiment, the light-mixing distance L and the light source mounting interval W for the location of each light source 5 in the light source unit can be configured to become nearly equal. When the light source mounting interval W is disproportionate as compared to the light-mixing distance L, the light emitted from the light sources 5 (i.e., the light source unit) may not reach a portion that is close to the light incoming surface 3C on the operative light-emitting area 3B or an insufficient amount of the light may reach the portion. Consequently, the above-described relation between the light source mounting interval W and the light-mixing distance L may cause a variability of the light intensity on the portion even on the operative light-emitting area 3B of the first surface 3a of the light guide 3.

When the light-mixing distance L is disproportionate as compared to the light source mounting interval W for the location of each light source 5 in the light source unit, the energy loss of the light emitted from the light sources 5 (i.e., the light source unit) between the light incoming surface 3C and the operative light-emitting area 3B may increase due to the long light-mixing distance, and therefore the light use efficiency of the light emitted from the light sources 5 may decrease. An advantageous light-mixing distance L can be within two times the distance of the light source mounting interval W in order to prevent from the decrease of the light use efficiency.

As described above, the light-mixing distance L and the light source mounting interval W for the location of each light source 5 in the light source unit can be nearly equal in an exemplary embodiment. The advantage(s) of the relation between the light-mixing distance L and the LED mounting pitch P in accordance with the formula I will now be given.

The result of evaluation tests 1 to 10 is described, which are carried out in order to search the parameters of the above-described components in case that the light emitted from the operative light-emitting area 3B on the first surface 3a of the light guide 3 can emitted without the color variability. Common elements with regard to the evaluation tests 1 to 10 will now be described.

A plurality of the light guides 3 and a plurality of light source units that includes the light sources 5 are made, and each of the light sources 5 can include the four-piece LEDs 17 described above. The plurality of the light source units, each with a unique light source mounting interval W are prepared. Each LED mounting pitch P of the LEDs 17 in the light sources 5 (the light source unit) can be the same with respect to each other. Each of the light source units is located adjacent the light incoming surface 3C of the light guide 3, and the three light colors of green, red and blue emitted from the light sources 5 (i.e., the light source unit) can enter into the light guide 3 via the light incoming surface 3C.

In this state, chromaticity values on the operative light-emitting area 3B of the first surface 3a of the light guide 3 are measured. In the case, the operative light-emitting area 3B of the first surface 3a is divided into 36 parts respectively in the X and the Y axial direction (total 36×36), and a chromaticity value on each of divided parts in a reticular pattern is measured. Then the chromaticity distribution on the operative light-emitting area 3B of the first surface 3a of the light guide 3 is measured.

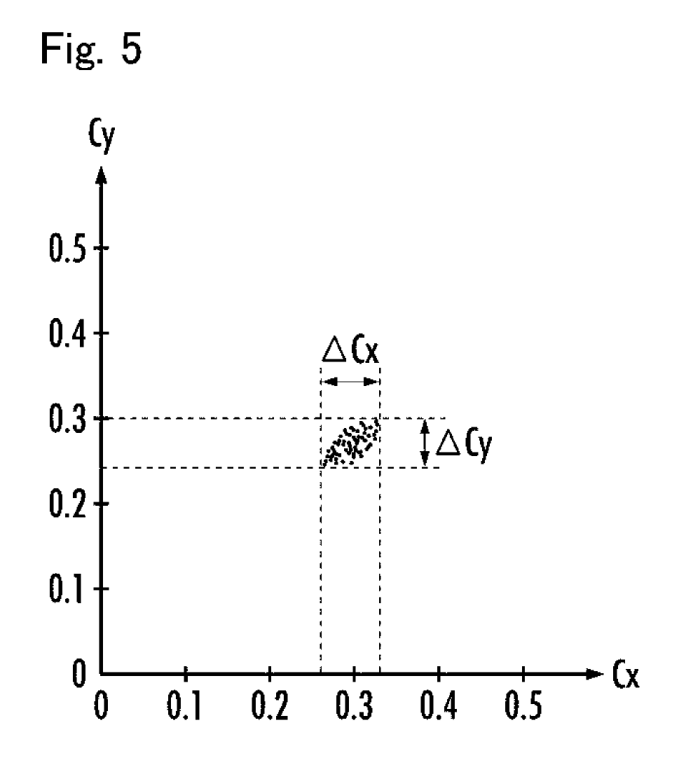

The measuring chromaticity is an x-axial component Cx and a y-axial component Cy on the chromaticity coordinate in accordance with the CIEI 1931 standard. FIG. 5 is a diagram showing an exemplary value of a chromaticity measured in evaluation tests of testing samples. In the evaluation tests 1 to 10, the respective chromaticity distributions of the testing samples are measured.

According to the respective chromaticity distributions, a difference ΔCx between a maximum value and a minimum value of the x-axial component Cx is calculated in order to evaluate the color variability in the x-axial component. In the same way, a difference ΔCy between a maximum value and a minimum value of the y-axial component Cy is calculated in order to evaluate the color variability in the y-axial component. A relation between each of the differences ΔCx and ΔCy and the LED mounting pitch P is developed. The differences ΔCx and ΔCy are hereinafter referred to as color variability indexes ΔCx and ΔCy, respectively.

In the surface light source device 1 for a back light unit of the LCD panel 100, it is generally intended for the device 1 to be designed/produced so that each errors of the x-axial component Cx and the y-axial component Cy can lie within the range of −0.003 to +0.003 with respect to a specific chromaticity. Therefore, each of the upper limits of the color variability indexes ΔCx and ΔCy is 0.006, and each of the color variability indexes ΔCx and ΔCy can be set smaller than each of these upper limits. The upper limits are hereinafter referred to as a color variability value limit, and a parameter in which the color variability indexes ΔCx and ΔCy can become smaller than each of the color variability value limit is hereinafter referred to as a specific color variability parameter. The evaluation tests 1 to 10 will now be described.

### [Evaluation Test 1]

The evaluation test 1 is a test in which the target chromaticity (Cx, Cy) of the light emitted from the operative light-emitting area 3B on the first surface 3a of the light guide 3 has a chromaticity of typical white light (0.29, 0.27) with the light-mixing distance L set at 30 millimeters and with the light source mounting interval W set at 29 millimeters. In this case, a length of the light guide 3 is 66.5 millimeters (36.5 millimeters+L), and a width thereof is 116 millimeters (4×W). A thickness of the light guide 3 is 1.5 millimeters, and the material thereof is an acrylic having a refractive index of 1.49.

The peak wavelength of emission spectrum of each of the red LED 17R, the green LED 17G and the blue LED 17B in the light sources 5 is 630 nanometers, 525 nanometers and 450 nanometers, respectively. The ratio of light flux of the LED 17R, the green LED 17G and the blue LED 17B becomes 37.7%, 30.7% and 31.6%, respectively. The mixed light having the target chromaticity (0.29, 0.27) can be generated by the above three LEDs 17R, 17G and 17B.

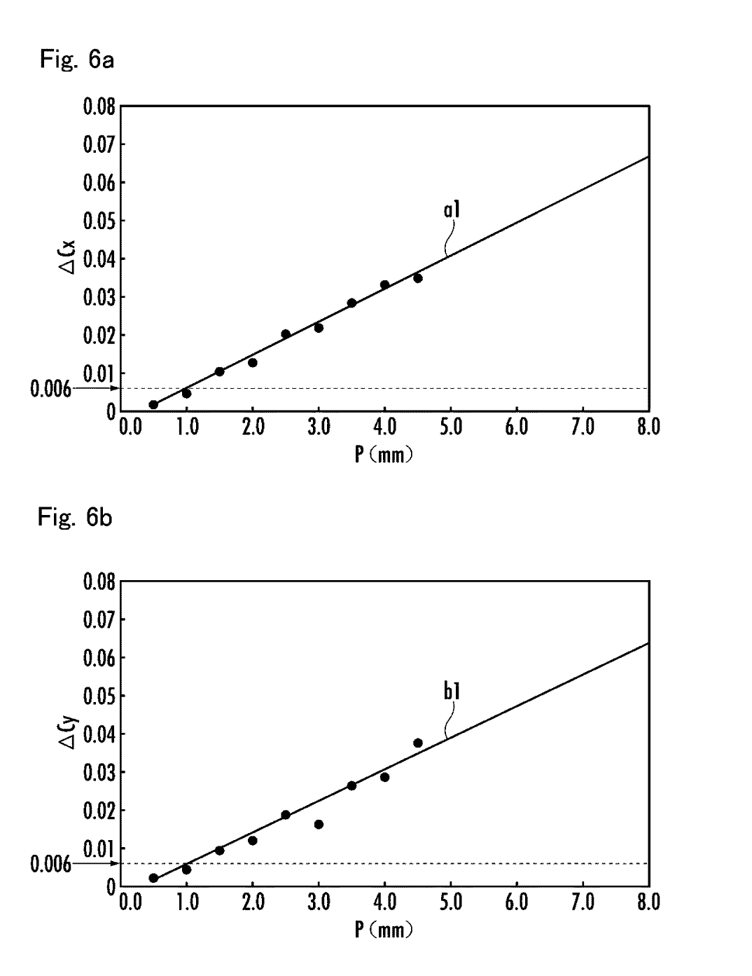

In the evaluation test 1, the chromaticity distribution pattern is measured using the above-described light guide 3 and the light sources 5, and the color variability indexes ΔCx and ΔCy are calculated. FIGS. 6a and 6b are, respectively, graphs showing the relationships between color variability indexes ΔCx and ΔCy and the LED mounting pitch P in evaluation test 1. Broken lines shown in FIGS. 6a and 6b are described as the color variability value limit (=0.006).

The relationships shown in FIGS. 6a and 6b are calculated by a least squares method, and the solid lines a1 and b1 are approximate lines. When the color variability index ΔCx becomes equal to the color variability value limit, the LED mounting pitch P is 1.04 millimeters. When the color variability index ΔCy becomes equal to the color variability value limit, the LED mounting pitch P is 1.11 millimeters. Thus, an LED mounting pitch P that has a value less than 1.04 millimeters can satisfy the specific color variability parameter in the testing samples of the evaluation test 1.

### [Evaluation Test 2]

The evaluation test 2 is a test in which the target chromaticity (Cx, Cy) of the light emitted from the operative light-emitting area 3B on the first surface 3a of the light guide 3 has a chromaticity (0.349, 0.398) with the light-mixing distance L and the light source mounting interval W the same as those of the testing samples in the evaluation test 1. The chromaticity (0.349, 0.398) is approximately 5,000 K in the color temperature, and the deviation value Δuv from the blackbody may become +0.02. The light guide 3 is the same as that of the testing samples used in the evaluation test 1.

The peak wavelength of emission spectrum of each of the red LED 17R, the green LED 17G and the blue LED 17B in the light sources 5 is the same as that of the testing samples used for the evaluation test 1. However, the ratio of light flux of the LED 17R, the green LED 17G and the blue LED 17B becomes 45.9%, 39.6% and 14.6%, respectively. The mixed light having the target chromaticity (0.349, 0.398) can be emitted by the above three LEDs 17R, 17G and 17B.

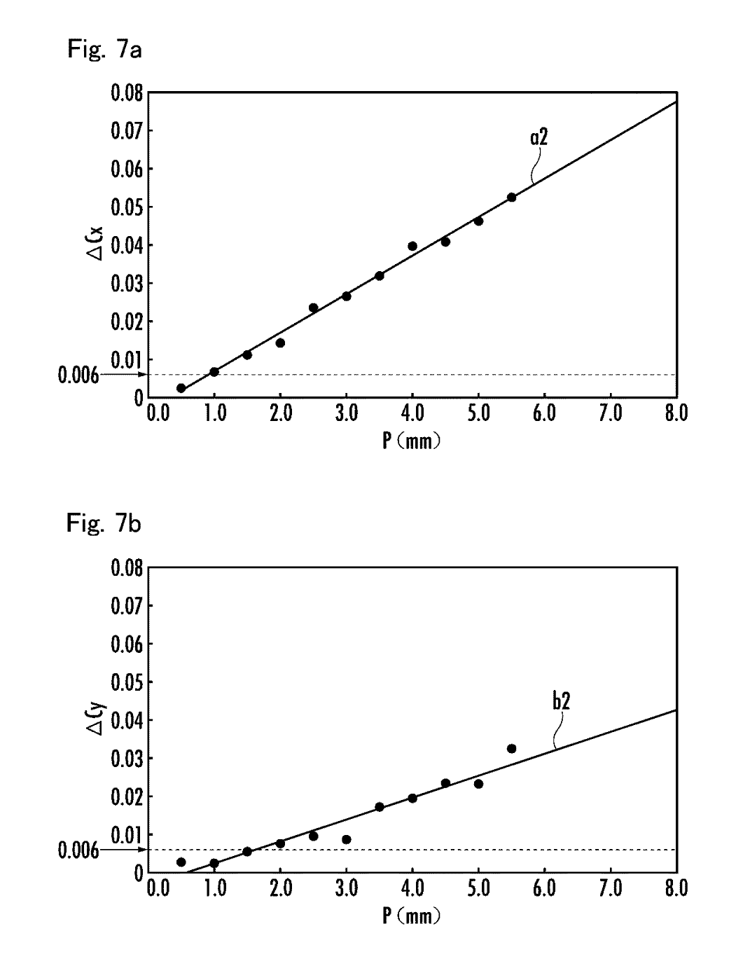

In the evaluation test 2, the chromaticity distribution pattern is measured using the above-described light guide 3 and the light sources 5, and the color variability indexes ΔCx and ΔCy are calculated. FIGS. 7a and 7b are, respectively, graphs showing the relationships between color variability indexes ΔCx and ΔCy and the LED mounting pitch P in the evaluation test 2. Broken lines shown in FIGS. 7a and 7b are described as the color variability value limit (=0.006).

The relationships shown in FIGS. 7a and 7b are calculated by a least squares method, and the solid lines a2 and b2 are approximate lines. When the color variability index ΔCx becomes equal to the color variability value limit, the LED mounting pitch P is 0.87 millimeters. When the color variability index ΔCy becomes equal to the color variability value limit, the LED mounting pitch P is 1.13 millimeters. Thus, an LED mounting pitch P that has a value less than 0.87 millimeters can satisfy the specific color variability parameter in the testing samples of the evaluation test 2.

### [Evaluation Test 3]

The evaluation test 3 is a test in which the target chromaticity (Cx, Cy) of the light emitted from the operative light-emitting area 3B on the first surface 3a of the light guide 3 has a chromaticity (0.341, 0.312) with the light-mixing distance L and the light source mounting interval W the same as those of the testing samples that are used for the evaluation test 1. The chromaticity (0.341, 0.312) is approximately 5,000 K in the color temperature, and the deviation value Δuv from the blackbody may become −0.02. The light guide 3 is the same as that of the testing samples used in the evaluation test 1.

The peak wavelength of emission spectrum of each of the red LED 17R, the green LED 17G and the blue LED 17B in the light sources 5 is the same as that of the testing samples used for the evaluation test 1. However, the ratio of light flux of the LED 17R, the green LED 17G and the blue LED 17B is 46.8%, 30.6% and 22.5%, respectively. The mixed light having the target chromaticity (0.341, 0.312) can be emitted by the above three LEDs 17R, 17G and 17B.

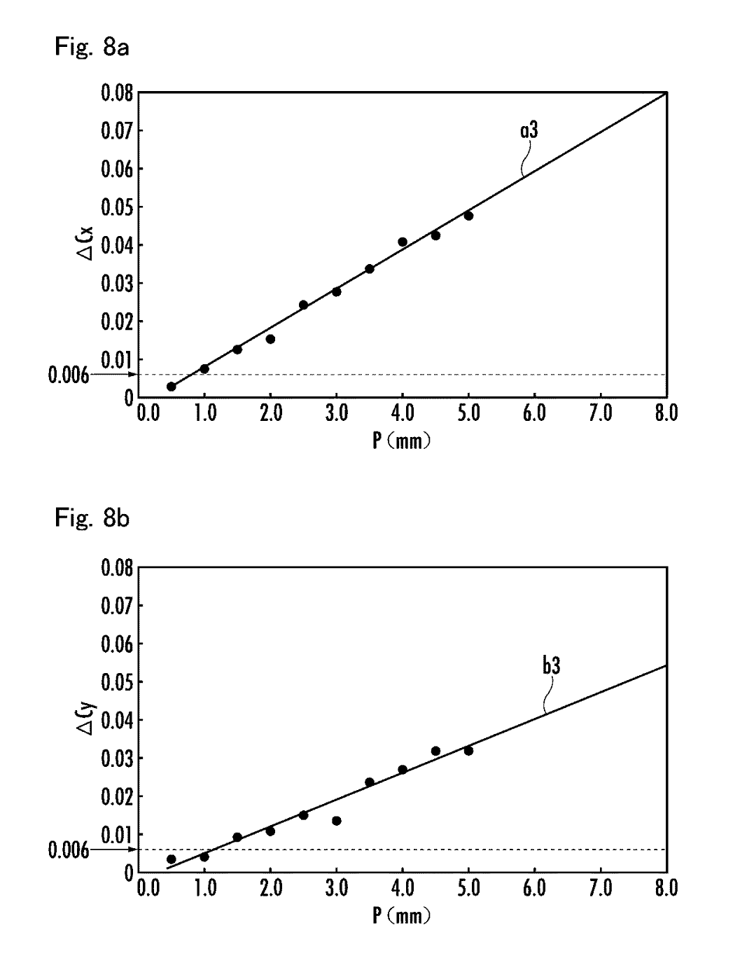

In the evaluation test 3, the chromaticity distribution pattern is measured using the above-described light guide 3 and the light sources 5, and the color variability indexes ΔCx and ΔCy are calculated. FIGS. 8a and 8b are, respectively, graphs showing the relationships between color variability indexes ΔCx and ΔCy and the LED mounting pitch P in the evaluation test 3. Broken lines shown in FIGS. 8a and 8b are described as the color variability value limit (=0.006).

The relationships shown in FIGS. 8a and 8b are calculated by a least squares method, and the solid lines a3 and b3 are approximate lines. When the color variability index ΔCx becomes equal to the color variability value limit, the LED mounting pitch P is 0.82 millimeters. When the color variability index ΔCy becomes equal to the color variability value limit, the LED mounting pitch P is 1.24 millimeters. Thus, an LED mounting pitch P that has a value less than 0.82 millimeters can satisfy the specific color variability parameter in the testing samples of the evaluation test 3.

### [Evaluation Test 4]

The evaluation test 4 is a test in which the target chromaticity (Cx, Cy) of the light emitted from the operative light-emitting area 3B on the first surface 3a of the light guide 3 has a chromaticity (0.235, 0.267) with the light-mixing distance L and the light source mounting interval W the same as those of the testing samples in the evaluation test 1. The chromaticity (0.235, 0.267) is approximately 30,000 K in the color temperature, and the deviation value Δuv from the blackbody may be within ±0.02. The light guide 3 is the same as that of the testing samples that are used for the evaluation test 1.

The peak wavelength of emission spectrum of each of the red LED 17R, the green LED 17G and the blue LED 17B in the light sources 5 is the same as that of the testing samples used for the evaluation test 1. However, the ratio of light flux of the LED 17R, the green LED 17G and the blue LED 17B is 24.8%, 37.0% and 38.2%, respectively. The mixed light having the target chromaticity (0.235, 0.267) can be generated by the above three LEDs 17R, 17G and 17B.

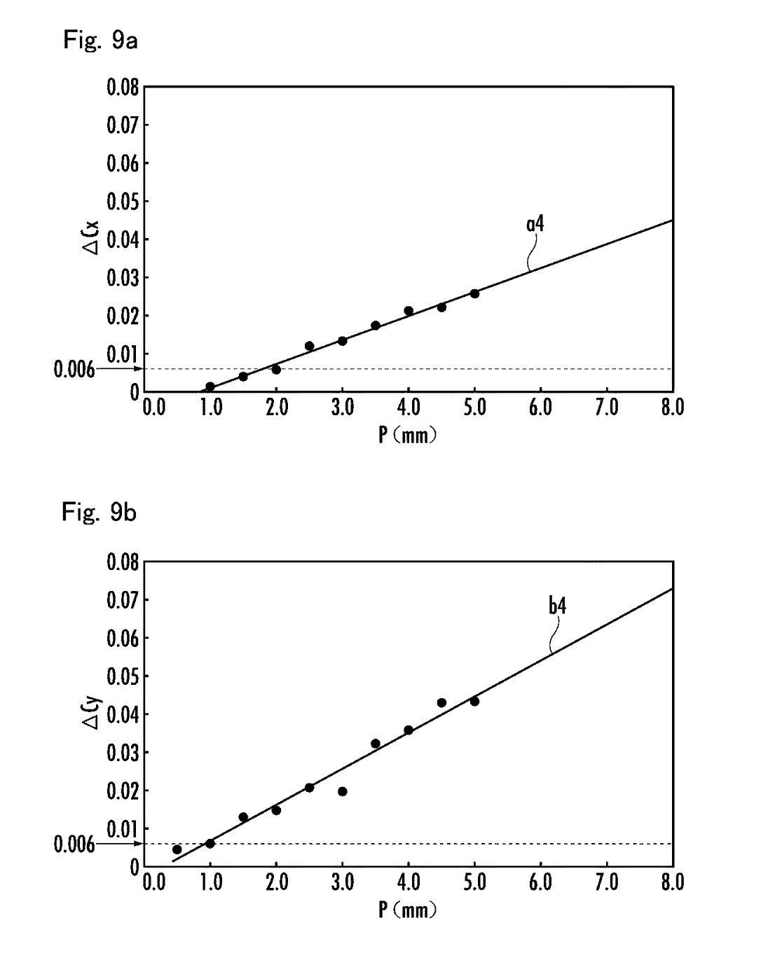

In the evaluation test 4, the chromaticity distribution pattern is measured using the above-described light guide 3 and the light sources 5, and the color variability indexes ΔCx and ΔCy are calculated. FIGS. 9a and 9b are, respectively, graphs showing the relationships between color variability indexes ΔCx and ΔCy and the LED mounting pitch P in the evaluation test 4. Broken lines shown in FIGS. 9a and 9b are described as the color variability value limit (=0.006).

The relationships shown in FIGS. 9a and 9b are calculated by a least squares method, and the solid lines a4 and b4 are approximate lines. When the color variability indexes ΔCx becomes equal to the color variability value limit, the LED mounting pitch P is 1.68 millimeters. When the color variability index ΔCy becomes equal to the permissible color variability value, the LED mounting pitch P is 0.89 millimeters. Thus, an LED mounting pitch P that has a value less than 0.89 millimeters can satisfy the specific color variability parameter in the testing samples of the evaluation test 4.

### [Evaluation Test 5]

The evaluation test 5 is a test in which the target chromaticity (Cx, Cy) of the light emitted from the operative light-emitting area 3B on the first surface 3a of the light guide 3 has a chromaticity (0.268, 0.237) with the light-mixing distance L and the light source mounting interval W the same as those of the testing samples in the evaluation test 1. The chromaticity (0.268, 0.237) is approximately 30,000 K in the color temperature, and the deviation value Δuv from the blackbody may be within −0.02. The light guide 3 is the same as that of the testing samples in the evaluation test 1.

The peak wavelength of emission spectrum of each of the red LED 17R, the green LED 17G and the blue LED 17B in the light sources 5 is the same as that of the testing samples used for the evaluation test 1. However, the ratio of light flux of the LED 17R, the green LED 17G and the blue LED 17B is 33.5%, 28.5% and 38.0%, respectively. The mixed light having the target chromaticity (0.268, 0.237) can be emitted by the above three LEDs 17R, 17G and 17B.

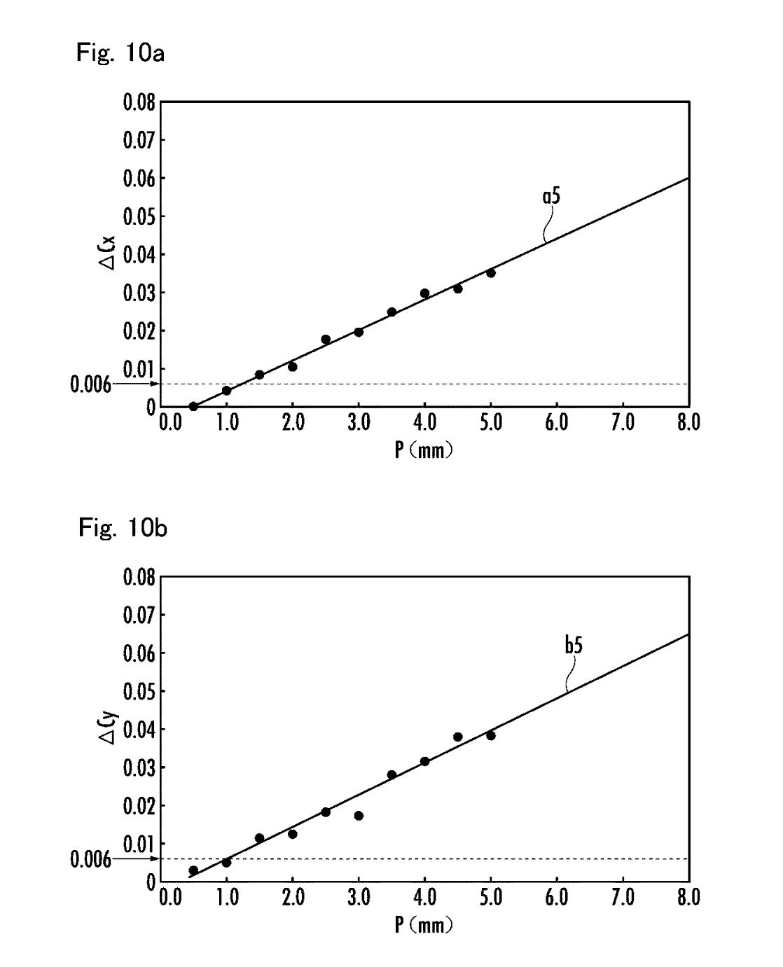

In the evaluation test 5, the chromaticity distribution pattern is measured using the above-described light guide 3 and the light sources 5, and the color variability indexes ΔCx and ΔCy are calculated. FIGS. 10a and 10b are, respectively, graphs showing the relationships between color variability indexes ΔCx and ΔCy and the LED mounting pitch P in the evaluation test 5. Broken lines shown in FIGS. 10a and 10b are described as the color variability value limit (=0.006).

The relationships shown in FIGS. 10a and 10b are calculated by a least squares method, and the solid lines a5 and b5 are approximate lines. When the color variability indexes ΔCx becomes equal to the color variability value limit, the LED mounting pitch P is 1.19 millimeters. When the color variability index ΔCy becomes equal to the color variability value limit, the LED mounting pitch P is 1.06 millimeters. Thus, an LED mounting pitch P that has a value less than 1.06 millimeters can satisfy the specific color variability parameter in the testing samples of the evaluation test 5.

### [Evaluation Test 6]

The evaluation test 6 is a test in which the target chromaticity (Cx, Cy) of the light emitted from the operative light-emitting area 3B on the first surface 3a of the light guide 3 has a chromaticity (0.29, 0.27) with the light-mixing distance L and the light source mounting interval W the same as those of the testing samples in the evaluation test 1. The chromaticity is the same as the typical white light in the evaluation test 1. The light guide 3 is also the same as that of the testing samples in the evaluation test 1.

The peak wavelength of emission spectrum of each of the red LED 17R, the green LED 17G and the blue LED 17B in the light sources 5 is, respectively, 630 nanometers, 520 nanometers and 440 nanometers, and therefore, is different from that of the evaluation tests 1 to 5. The ratio of light flux of the LED 17R, the green LED 17G and the blue LED 17B is 37.5%, 32.8% and 30.1%, respectively. The mixed light having the target chromaticity (0.29, 0.27) can be emitted by the above three LEDs 17R, 17G and 17B.

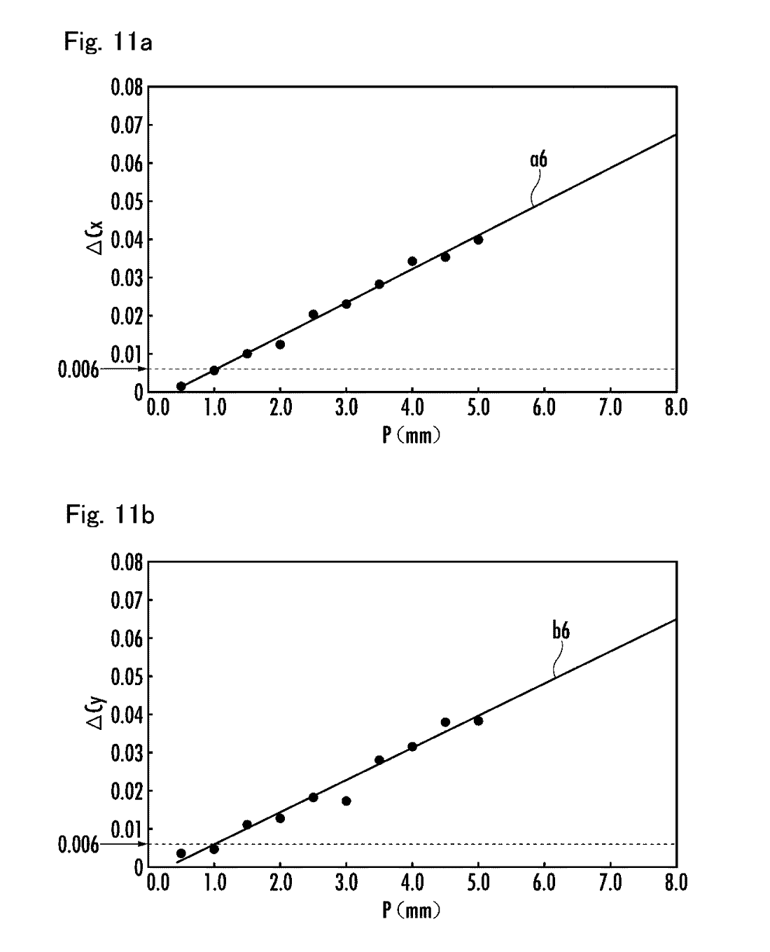

In the evaluation test 6, the chromaticity distribution pattern is measured using the above-described light guide 3 and the light sources 5, and the color variability indexes ΔCx and ΔCy are calculated. FIGS. 11a and 11b are, respectively, graphs showing the relationships between color variability indexes ΔCx and ΔCy and the LED mounting pitch P in the evaluation test 6. Broken lines shown in FIGS. 11a and 11b are described as the color variability value limit (=0.006).

The relationships shown in FIGS. 11a and 11b are calculated by a least squares method, and the solid lines a6 and b6 are approximate lines. When the color variability index ΔCx becomes equal to the color variability value limit, the LED mounting pitch P is 1.04 millimeters. When the color variability index ΔCy becomes equal to the color variability value limit, the LED mounting pitch P is 1.03 millimeters. Thus, an LED mounting pitch P that has a value less than 1.03 millimeters can satisfy the specific color variability parameter in the testing samples of the evaluation test 6.

### [Evaluation Test 7]

The evaluation test 7 is a test in which the target chromaticity (Cx, Cy) of the light emitted from the operative light-emitting area 3B on the first surface 3a of the light guide 3 has a chromaticity (0.29, 0.27) with the light-mixing distance L and the light source mounting interval W the same as those of the testing samples used in the evaluation test 1. The chromaticity is the same as the typical white light in the evaluation test 1. The light guide 3 also is the same as that of the testing samples that are used for the evaluation test 1.

The peak wavelength of emission spectrum of each of the red LED 17R, the green LED 17G and the blue LED 17B in the light sources 5 is, respectively, 650 nanometers, 550 nanometers and 460 nanometers, and therefore is different from that of the testing samples used for the evaluation tests 1 to 6. The ratio of light flux of the LED 17R, the green LED 17G and the blue LED 17B is 47.8%, 23.2% and 29.0%, respectively. The mixed light having the target chromaticity (0.29, 0.27) can be emitted by the above three LEDs 17R, 17G and 17B.

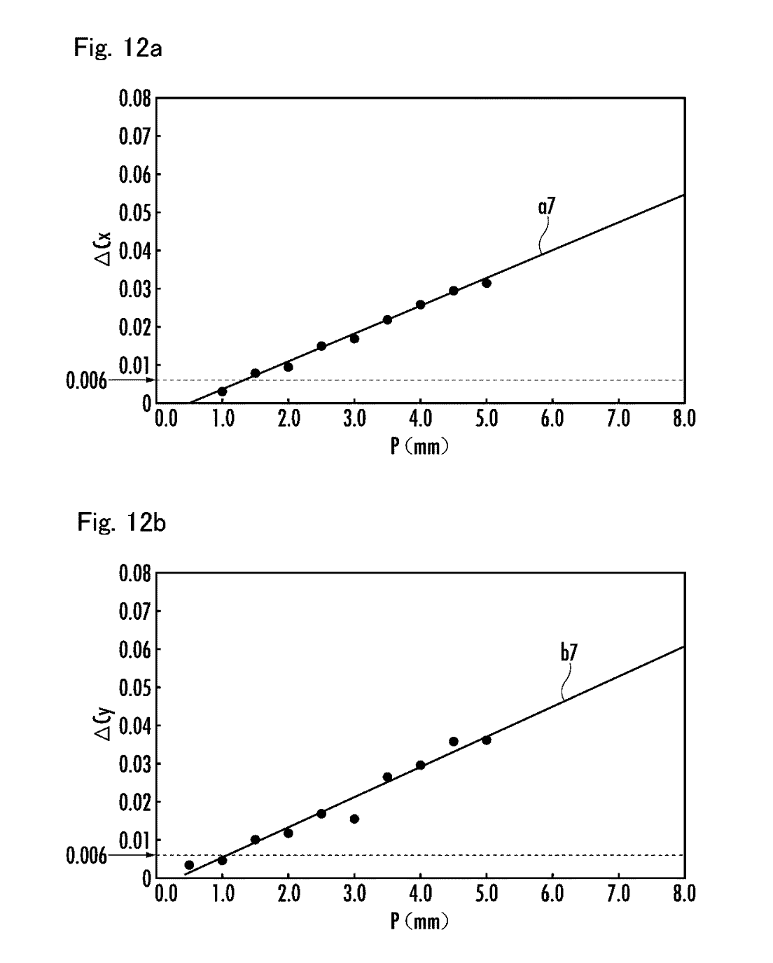

In the evaluation test 7, the chromaticity distribution pattern is measured using the above-described light guide 3 and the light sources 5, and the color variability indexes ΔCx and ΔCy are calculated. FIGS. 12a and 12b are, respectively, graphs showing the relationships between color variability indexes ΔCx and ΔCy and the LED mounting pitch P in the evaluation test 7. Broken lines shown in FIGS. 12a and 12b are described as the color variability value limit (=0.006).

The relationships shown in FIGS. 12a and 12b are calculated by a least squares method, and the solid lines a7 and b7 are approximate lines. When the color variability indexes ΔCx becomes equal to the permissible color variability value, the LED mounting pitch P is 1.34 millimeters. When the color variability index ΔCy becomes equal to the color variability value limit, the LED mounting pitch P is 1.10 millimeters. Thus, an LED mounting pitch P that has a value less than 1.10 millimeters can satisfy the specific color variability parameter in the testing samples of the evaluation test 7.

### [Evaluation Test 8]

The evaluation test 8 is a test in which the material of the light guide 3 in the evaluation test 8 is different from that in the evaluation test 1. The material of the light guide 3 is polycarbonate having a refraction index of 1.58. The other specifications of the light guide 3, the light sources 5 and the target chromaticity are the same as the evaluation test 1.

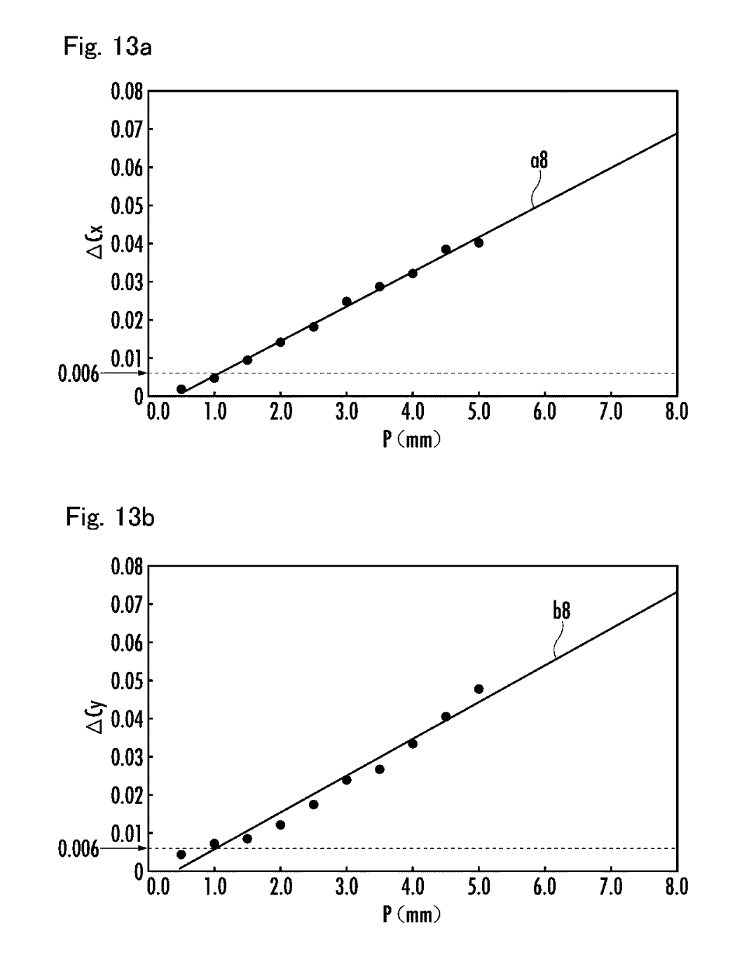

In the evaluation test 8, the chromaticity distribution pattern is measured using the above-described light guide 3 and the light sources 5, and the color variability indexes ΔCx and ΔCy are calculated. FIGS. 13a and 13b are, respectively, graphs showing the relationships between color variability indexes ΔCx and ΔCy and the LED mounting pitch P in the evaluation test 8. Broken lines shown in FIGS. 13a and 13b are described as the color variability value limit (=0.006).

The relationships shown in FIGS. 13a and 13b are calculated by a least squares method, and the solid lines a8 and b8 are approximate lines. When the color variability indexes ΔCx becomes equal to the color variability value limit, the LED mounting pitch P is 1.05 millimeters. When the color variability index ΔCy becomes equal to the color variability value limit, the LED mounting pitch P is 0.97 millimeters. Thus, the LED mounting pitch P that has a value less than 0.97 millimeters can satisfy the specific color variability parameter in the testing samples of the evaluation test 8.

### [Evaluation Test 9]

The evaluation test 9 is a test in which the light-mixing distance L, the light source mounting interval W and the length and the width of the light guide 3 are different from those in the evaluation test 1. The light-mixing distance L is 45 millimeters, and the light source mounting interval W is 43.5 millimeters in the evaluation test 9. In addition, the length of the light guide 3 in the Y axial direction is 81.5 millimeters (36.5 millimeters+L), and the width in the X axial direction is 174 millimeters (4×W). The thickness and the material of the light guide 3 are the same as those of the evaluation test 1, and the light sources 5 and the target chromaticity are the same as the evaluation test 1.

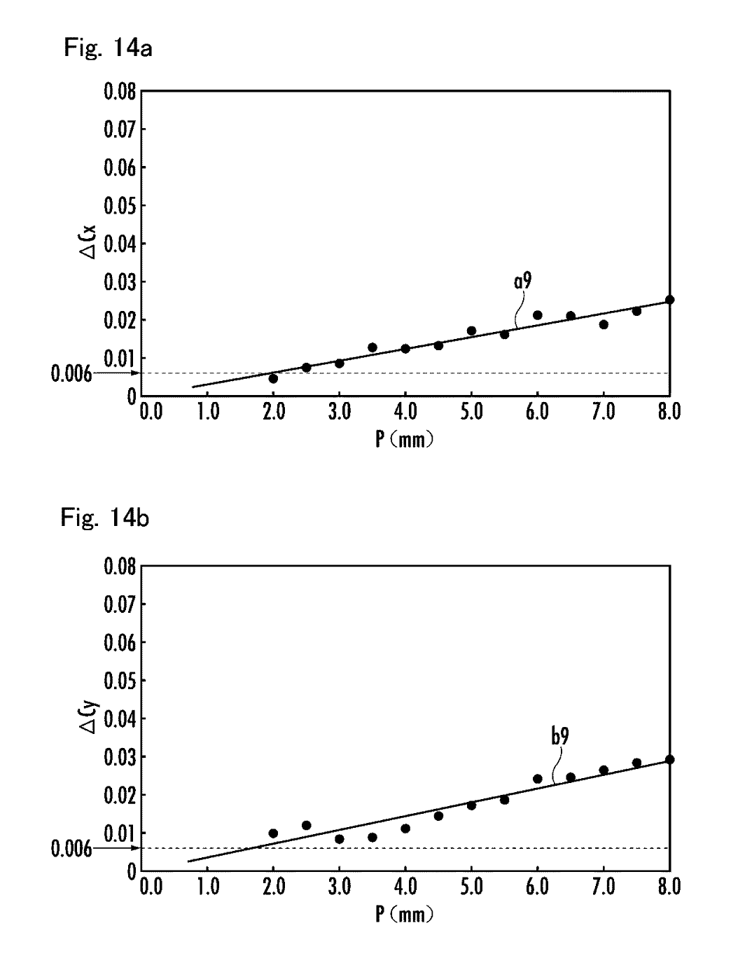

In the evaluation test 9, the chromaticity distribution pattern is measured using the above-described light guide 3 and the light sources 5, and the color variability indexes ΔCx and ΔCy are calculated. FIGS. 14a and 14b are, respectively, graphs showing the relationships between color variability indexes ΔCx and ΔCy and the LED mounting pitch P in evaluation test 9. Broken lines shown in FIGS. 14a and 14b are described as the color variability value limit (=0.006).

The relationships shown in FIGS. 14a and 14b are calculated by a least squares method, and the solid lines a9 and b9 are approximate lines. When the color variability index ΔCx becomes equal to the color variability value limit, the LED mounting pitch P is 1.75 millimeters. When the color variability index ΔCy becomes equal to the permissible color variability value, the LED mounting pitch P is 1.54 millimeters. Thus, an LED mounting pitch P that has a value less than 1.54 millimeters can satisfy the specific color variability parameter in the testing samples of the evaluation test 9.

### [Evaluation Test 10]

The evaluation test 10 is a test in which the light-mixing distance L, the light source mounting interval W and the length and the width of the light guide 3 are different from those of the testing samples that are used for the evaluation tests 1 and 9. The light-mixing distance L is 60 millimeters, and the light source mounting interval W is 58 millimeters in the evaluation test 10. In addition, the length of the light guide 3 in the Y axial direction is 96.5 millimeters (36.5 millimeters+L), and the width in the X axial direction is 232 millimeters (4×W). The thickness and the material of the light guide 3 are the same as those of the testing samples used for the evaluation test 1, and the light sources 5 and the target chromaticity are the same as the evaluation test 1.

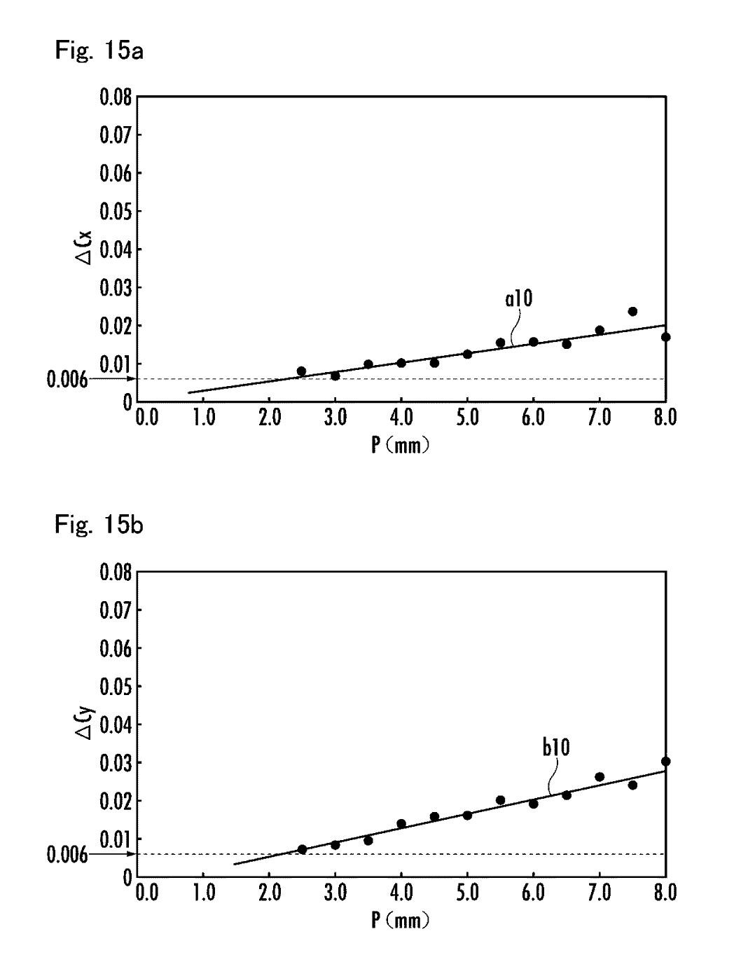

In the evaluation test 10, the chromaticity distribution pattern is measured using the above-described light guide 3 and the light sources 5, and the color variability indexes ΔCx and ΔCy are calculated. FIGS. 15a and 15b are, respectively, graphs showing the relationships between color variability indexes ΔCx and ΔCy and the LED mounting pitch P in evaluation test 10. Broken lines shown in FIGS. 15a and 15b are described as the color variability value limit (=0.006).

The relationships shown in FIGS. 15a and 15b are calculated by a least squares method, and the solid lines a10 and b10 are approximate lines. When the color variability index ΔCx becomes equal to the permissible color variability value, the LED mounting pitch P is 2.05 millimeters. When the color variability index ΔCy becomes equal to the permissible color variability value, the LED mounting pitch P is 2.19 millimeters. Thus, an LED mounting pitch P that has a value less than 2.05 millimeters can satisfy the specific color variability parameter in the testing samples of the evaluation test 9.

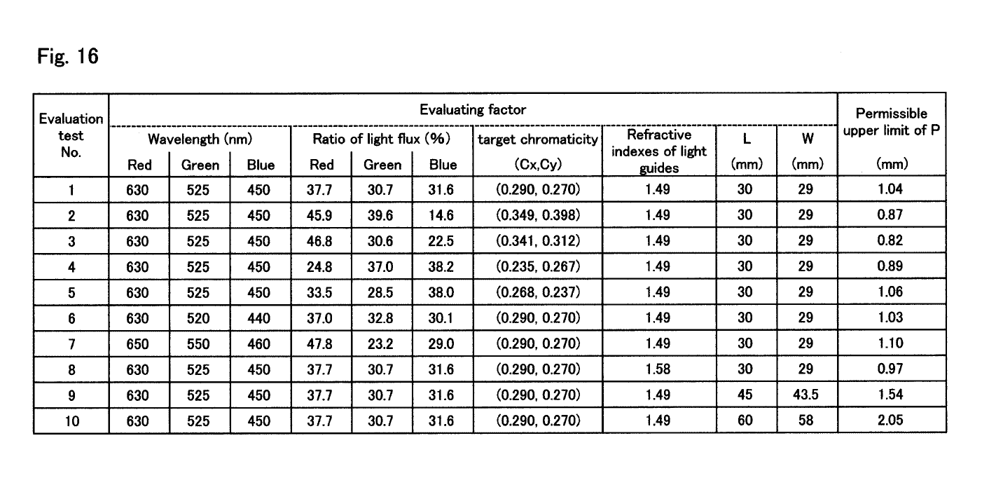

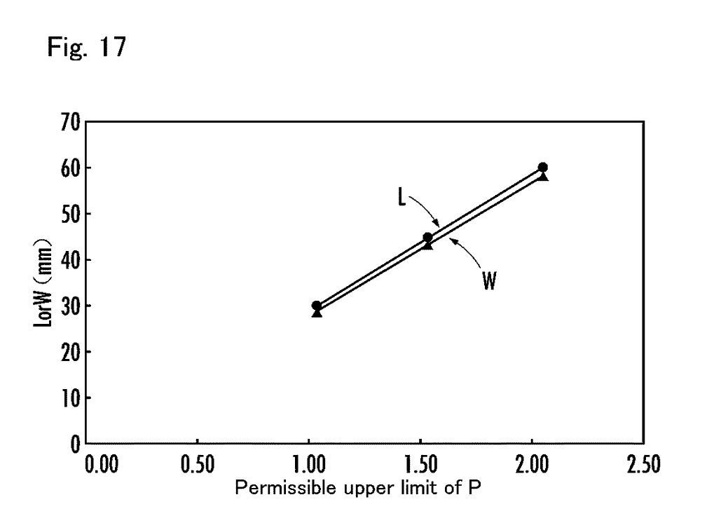

FIG. 16 is a table showing testing factors and testing results for advantageous upper limits of the LED mounting pitches P in the evaluation tests 1 to 10. The following discussion focuses on the evaluation tests 1, 9 and 10 in that the light-mixing distance L and the light source mounting interval W are different with respect to each other. FIG. 17 is a graph showing the relationships between light-mixing distances L and intervals W for location of light sources and the permissible upper limits of the LED mounting pitches P in the evaluation tests 1, 9 and 10.

When the light-mixing distance L is substantially equal to the light source mounting interval W, the light-mixing distance L can be directly proportionate to the advantageous upper limit of the LED mounting pitch P as shown in FIG. 17. The following discussion focuses on the evaluation tests 1 to 8 in that the light-mixing distance L and the light source mounting interval W are substantially the same with respect to each other. When the light-mixing distance L is 30 millimeters and when the LED mounting pitch P is more than 1.10 millimeters, the specific color variability parameter may not be satisfied due to a specification of the target chromaticity, and so on.

Therefore, when the light-mixing distance is 30 millimeters, the LED mounting pitch P should be less than 1.10 millimeters in order to satisfy the specific color variability parameter. In this case, the light-mixing distance L/P of the LED mounting pitch P is approximately 27 (30/1.10). Thus, when the light-mixing distance L is 30 millimeters, L/P is 27, or more, in order for the LED mounting pitch P to become less than 1.10 millimeters.

Because of the above-described description and the proportionate relation between the light-mixing distance L and the permissible upper limit values, the formula 1 can be given as the factor for satisfying the specific color variability parameter. Thus, the surface light source device 1 of the disclosed subject matter can be designed so that the light-mixing distance L and the LED mounting pitch P can conform to the formula 1.

According to the surface light source device 1 of the disclosed subject matter, the light source device 1 can emit the white light, in which the color variability is less than 0.006 in the light emitted from the operative light-emitting area 3B on the first surface 3a of the light guide 3 by satisfy the formula 1. The white light can be used as the back light unit for the LCD panel 100, and therefore the LCD unit using the surface light source device 1 can display the LCD panel 100 with high quality.

In addition, because the three light colors are mixed in the light-mixing area 3A that does not emit light towards the outside, the light sources 5 can be located close to the light incoming surface 3C of the light guide 3 wherever possible. The light emitted from the light sources 5 can enter the light guide 3 via the light incoming surface 3a with very little energy loss, and the decrease of the light use efficiency thereof can be prevented.

Furthermore, the light that enters into the light guide 3 via the light incoming surface 3C need not be diffused near the light incoming surface 3C due to the light-mixing area 3A. Thus, a concave portion on the light incoming surface 3C is not required to diffuse the light, and the light that enters into the light guide 3 can be efficiently emitted from the operative light-emitting area 3B on the first surface 3a of the light guide 3. The flat surface of the light incoming surface 3C can result in a cost reduction of the light guide 3 because of the simple structure.

Variations of the above-described exemplary embodiment will now be given. In the exemplary embodiment, the LED mounting pitch P between the adjacent LEDs is described as the same distance. However, if the maximum pitch among the adjacent LEDs is defined as the mounting pitch P while conforming to the formula 1, then other pitches can become narrower than the maximum pitch.

At least one of the light sources 5 of the exemplary embodiment is described as including four LEDs, which can be two green LEDs 17G, the red LED 17R and the blue LED 17B. However, any of the light sources 5 can include one each of a green LED, a red LED and a blue LED, or, alternatively, can include a plurality of green LEDs, red LEDs and blue LEDs according to each characteristic of the LEDs and a specification of the surface light source device 1.

The above-described LEDs 17 can include the green, the red and the blue LEDs. The LEDs 17 are not necessarily limited to these three light colors, but various color LEDs can be used as the LEDs 17 if the mixed light becomes an advantageous light color. In addition, an organic EL, an inorganic EL, and the like, can be used as the light-emitting chip.

In the exemplary embodiment, the plurality of knurls 15 is formed on the second surface 3b of the light guide 3 as the uniform light-emitting treatment. A dot pattern, printing ink, and the like, can be formed on the second surface 3b as the uniform light-emitting treatment in any manner known in the art. In addition, the second surface 3b for the uniform light-emitting treatment can also be inclined so as to gradually become thin as the second surface 3b is away from the light incoming surface 3C. Furthermore, a large surface light source device can also be formed by combing a plurality of the surface light sources in a reticular pattern.

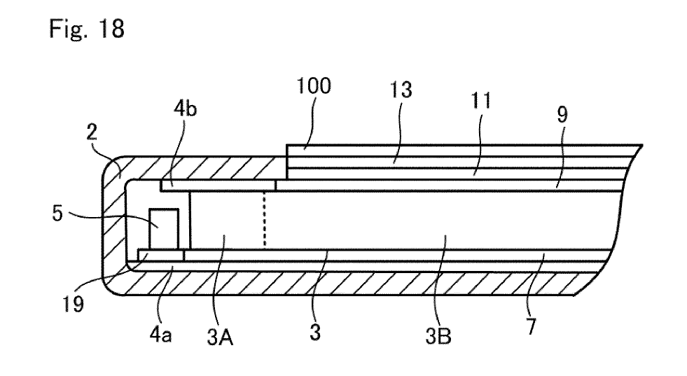

An exemplary embodiment of an LCD unit using the surface light source device 1 will now be described. FIG. 18 is a partial enlarged cross-section view depicting a LCD unit using the surface light source device 1. The LCD unit can be accomplished by mounting a LCD panel 100 on the first surface of the prism sheet 13. In this exemplary embodiment, either the first prism sheet 11 or the second prism sheet 13 can be eliminated according to the specification of the LCD unit. The prism sheets 11 and 13 can be configured to define the light distribution of the surface light source device 1 in the X and the Y axial direction, and the diffusing sheet 9 can be configured to diffuse the light of the surface light source device 1. Thus, the both prism sheets 11 and 13 can also eliminated from the LCD unit in order to reduce the cost.

The casing 2 can be composed of an opaque material such as a metal, a resin, etc. At least the base board 19 that mounts the light sources 5 thereon, the reflecting sheet 7, the light guide 3 and the diffusing sheet 9 can be attached to the casing 2 via an adhesive material 4a so as not emit light on the light-mixing area 3A of the light guide 3. A white adhesive material 4b that has a high reflectance also can be located between the casing 2 and the light guide 3 in order to adequately fix these parts in the casing 2 and in order to improve the light use efficiency by reflecting light on the light-mixing area 3A.

The surface light source device 1 of the exemplary embodiments can be configured for use as a light source of a back light unit in a LCD unit for use in a personal computer, display devices, etc. In these cases, the LCD unit can be configured to locate the operative light-emitting area 3B of the light guide 3 of the surface light source device 1 in the rear of a LCD panel, and therefore, the LCD unit can exhibit a display with high quality such as very little color variability, and so on.

However, these surface light source devices can also be configured for use as other light sources, such as for flat lighting and the like, without departing from the spirit and scope of the presently disclosed subject matter. While there has been described what are at present considered to be exemplary embodiments of the invention, it will be understood that various modifications may be made thereto, and it is intended that the appended claims cover such modifications as fall within the true spirit and scope of the invention. All conventional art references described above are herein incorporated in their entirety by reference.

What is claimed is:

1. A surface light source device comprising:
a light guide formed from a transparent resin and having a first surface, a second surface, and a light incoming surface, the light guide having a rectangular shape with respect to the first surface, the light incoming surface thereof being substantially perpendicular to the first surface, and the light guide including a light-mixing area that extends from the light incoming surface to a virtual surface that is substantially parallel with the light incoming surface and is spaced a distance (L) away from the light incoming surface;
a reflecting sheet having a first surface and a second surface formed in a rectangular shape, and the first surface of the reflecting sheet being located adjacent the second surface of the light guide; and
a plurality of light sources located adjacent the light incoming surface of the light guide so as to align along the light incoming surface substantially in parallel with the light incoming surface and a virtual extending surface of the first surface of the light guide, each of the light sources including a plurality of light-emitting chips configured to emit a different color light having a light-emitting angle with respect to each other, each of the light-emitting chips located at an interval in the light source so as to face the light incoming surface of the light guide substantially in parallel with the light incoming surface and the virtual extending surface of the first surface of the light guide, and wherein a widest interval between the adjacent light-emitting chips located in each of the light sources is substantially equal to or less than L/27.

2. The surface light source device according to claim 1, wherein the plurality of light-emitting chips includes two green LEDs, a red LED, and a blue LED, and the light-emitting chips are located so as to adjacently align the red LED and the blue LED between the two green LEDs.

3. The surface light source device according to claim 1, wherein each of the light-emitting angles of the light-emitting chips is substantially zero degree with respect to the light incoming surface of the light guide and each of the light distribution patterns of the light-emitting chips is configured to form a lambertian radiation pattern substantially in parallel with the first surface of the light guide.

4. The surface light source device according to claim 2, wherein each of the light-emitting angle of the light-emitting chips is substantially zero degree with respect to the light incoming surface of the light guide, and each of the light distribution patterns of the light-emitting chips is configured to form a lambertian radiation pattern substantially in parallel with the first surface of the light guide.

5. The surface light source device according to claim 1, wherein a uniform light-emitting treatment is formed on the second surface of the light guide.

6. The surface light source device according to claim 2, wherein a uniform light-emitting treatment is formed on the second surface of the light guide.

7. The surface light source device according to claim 3, wherein a uniform light-emitting treatment is formed on the second surface of the light guide.

8. The surface light source device according to claim 4, wherein a uniform light-emitting treatment is formed on the second surface of the light guide.

9. A surface light source device comprising:
a light guide having a first surface and a second surface and a light incoming surface composed of a transparent resin and formed in a rectangular shape in view of the first surface, the second surface including a uniform light-emitting treatment, the light incoming surface being substantially perpendicular to the first surface, and the light guide including a light-mixing area that extends from the light incoming surface to a virtual surface that is substantially parallel with the light incoming surface and is a distance (L) away from the light incoming surface;
a reflecting sheet having a first surface and a second surface formed in a rectangular shape, and the first surface of the reflecting sheet being located adjacent the second surface of the light guide;
a diffusing sheet having a first surface and a second surface formed in a rectangular shape, and the second surface of the diffusing sheet being located adjacent the first surface of the light guide;
a plurality of light sources mounted on a base board, each of the plurality of light sources located at a regular interval adjacent the light incoming surface of the light guide so as to align along the light incoming surface substantially in parallel with the light incoming surface and a virtual extending surface of the first surface of the light guide, each of the light sources including a plurality of light-emitting chips that emits a different color light having a light-emitting angle with respect to each other, each of the light-emitting chips located at an interval in the light source so as to face the light incoming surface of the light guide substantially in parallel with the light incoming surface and the first surface of the light guide, and wherein a widest interval between adjacent light-emitting chips located in each of the light sources is substantially equal to or less than L/27; and
a casing covering at least the light-mixing area of the light guide and the light sources.

10. The surface light source device according to claim 9, wherein the plurality of light-emitting chips includes two green LEDs and a red LED and a blue LED, and the light-emitting chips are located so as to adjacently align the red LED and the blue LED between the two green LEDs.

11. The surface light source device according to claim 9, wherein each of the light-emitting angles of the light-emitting chips is substantially zero degree with respect to the light incoming surface of the light guide and each of the light distribution patterns of the light-emitting chips is configured to form a lambertian radiation pattern substantially in parallel with the first surface of the light guide.

12. The surface light source device according to claim 10, wherein each of the light-emitting angles of the light-emitting chips is substantially zero degree with respect to the light incoming surface of the light guide and each of the light distribution patterns of the light-emitting chips is configured to form a lambertian radiation pattern substantially in parallel with the first surface of the light guide.

13. The surface light source device according to claim 9, wherein the widest interval between the adjacent light-emitting chips located in each of the light sources is substantially equal to the regular interval between adjacent light sources in the plurality of light sources.

14. The surface light source device according to claim 10, wherein the widest interval between the adjacent light-emitting chips located in each of the light sources is substantially equal to the regular interval between adjacent light sources in the plurality of light sources.

15. The surface light source device according to claim 11, wherein the widest interval between the adjacent light-emitting chips located in each of the light sources is substantially equal to the regular interval between adjacent light sources in the plurality of light sources.

16. The surface light source device according to claim 12, wherein the widest interval between the adjacent light-emitting chips located in each of the light sources is substantially equal to the regular interval between adjacent light sources in the plurality of light sources.

17. A liquid crystal display unit including the surface light source device according to claim 1, comprising:
at least one prism sheet having a first surface and a second surface, the second surface of the prism sheet being located adjacent the first surface of the diffusing sheet; and
a liquid crystal display adjacent the first surface of the at least one prism sheet.

18. A liquid crystal display unit including the surface light source device according to claim 4, comprising:
at least one prism sheet having a first surface and a second surface, the second surface of the prism sheet being located adjacent the first surface of the diffusing sheet; and
a liquid crystal display adjacent the first surface of the at least one prism sheet.

19. A liquid crystal display unit including the surface light source device according to claim 9, comprising:
at least one prism sheet having a first surface and a second surface, the second surface of the prism sheet being located adjacent the first surface of the diffusing sheet; and
a liquid crystal display adjacent the first surface of the at least one prism sheet.

20. A liquid crystal display unit including the surface light source device according to claim 12, comprising:
at least one prism sheet having a first surface and a second surface, the second surface of the prism sheet being located adjacent the first surface of the diffusing sheet; and
a liquid crystal display adjacent the first surface of the at least one prism sheet.
